(19) United States
(12) Patent Application Publication
(10) Pub. No.: US 2007/0278782 A1
(43) Pub. Date: Dec. 6, 2007

(54) Children's book

(76) Inventor: Anne Paivi Karkkainen, Temple City, CA (US)

Correspondence Address: W. Edward Johansen, 11661 San Vicente Boulevard, Los Angels, CA, 90049, US

(21) Appl. No.: 11/446,574

(22) Filed: Jun. 1, 2006

(51) Int. Cl. B42D 1/00

(52) U.S. Cl. 281/15.1

(57) ABSTRACT

The present invention is a book that includes a front cover, a rear cover, a plurality of pages and binding. The binding mechanically couples the front cover, the rear cover and the pages together. Each page has content material that has been rotated ninety degrees so that a very young baby who spends most of his time awake lying on his back can see the content material from a right angle since his view of the content material corresponds to the baby's perspective.

### BACKGROUND OF THE INVENTION

1. Field of the Invention

The present invention relates to a developmentally appropriate board book for very young babies.

2. Description of Prior Art

U.S. Pat. No. 5,626,365 teaches a two-way book especially useful when reading to a group of young children. The book includes a binding and a plurality of pairs of pages that are movably attached to the binding. Each pair of pages has a first page and a second page with corresponding indicia thereon. Each pair of pages is also movable between an open position and a viewing position. In the open position, the first and second pages of at least one pair are substantially adjacent one another with the binding extending therebetween. In the demonstrating position, the first and second pages of one pair face opposite one another with the remaining pairs of book pages therebetween. Furthermore, the second page faces the reader of the book and the first page faces the listener of the reader so that the listener can observe the indicia as the reader reads the book. Preferably, the indicia on each page of a pair of pages are identical and include both a text and an illustration. An alternative embodiment provides for indicia on side-by-side pages to be simultaneously displayed and read by the listener and reader. This invention relates to a two-way book that is specifically useful when reading aloud to young children. More specifically, the book has a specially designed page format that allows children, typically seated facing the reader, to not only listen to the story being read from the book by the reader, but to simultaneously read along and view the corresponding illustration. Childcare providers and elementary teachers are typically unable to read to the children under their care or in their class on a one on one basis. When an adult is reading to a group of young children, the children typically sit opposite and facing the reader. The reader must read the text of each page and then turn the book to face the children so that they can see the illustrations. This procedure is obviously very awkward. Furthermore, the children cannot follow the text as it is read or view the illustrations as it is read, which would both enhance their reading skills as well as their attentiveness.

U.S. Pat. No. 4,606,554 teaches a children's book that is made of a plurality of sheets bound between a front and rear cover. Each sheet is printed with pictures or the like, and when the book is opened, the right side pages are topsy-turvy to the left side pages for being seen from opposite directions. This invention relates generally to children's books. More particularly it relates to such children books that are known as activity or busy-work books as for example: coloring books or puzzle picture books such as contain “Follow the Dot” diagrams, or the like; and is an improvement over the U.S. Pat. No. 1,584,062, U.S. Pat. No. 3,271,091 and U.S. Pat. No. 4,073,070. It is well known that today all such children books are made for a child to entertain himself alone, but sometimes the child wishes for friend to participate together with him in the activity. This is usually not convenient to do because the children crowd each other while alongside one another, even if one is working on the left side page and the other is working on the right side page of the book. This can promote pushing one another and dissension, and so is in need of an improvement.

U.S. Pat. No. 6,626,536 teaches a device for assisting the development of an infant's visual acuity and for transferring the mother's scent to an infantile environment. Supple fabric contacts an area of the mother's body for absorbing a portion of the mother's scent and is thereafter transferred and attached to the infantile environment for venting the transferred scent about the infantile environment. The supple fabric is also includes a contrasted black and white pattern for assisting the development of the infant's visual acuity. A second side of the device can be supplied with a neutral color. In the most general sense, the present invention relates to devices that can be attached to infantile environment, such as incubators, cradles, cribs or bassinets. The invention is especially useful in hospital wards for newborns and premature babies. Due to the highly contrasted colors about or on the device, the training of the infant's visual acuity can be enhanced. In conjunction with the highly contrasted colors, a part of the present invention is created from fabrics or other supple materials that can absorb and thereafter transfer a portion of the scent of the infant's mother to a location apart from the mother. When the device is placed near the infantile environment, the mother's scent is vented about the infant's environment. In the absence of the mother the infant's olfactory senses can be stimulated by the mother's scent.

U. S. Patent Application: No. 2004/0222624 teaches a combination book that has a series of panels, at least one of the panels having a printed feature. The panels are in end-to-end relationship around a hinge line so as to be foldable in a fan-like mode and the first panel and the last panel in the series having respectively free-ends. The free end of the first panel and the fee end of the last panel are connectable together when the panels are opened and extended such that the free ends can be brought into contact. A connection feature of the free end of the first panel is for mating engagement with a complementary mating connection feature on the free end of the last panel. The panels in a first mode are readable sequentially as a book when successive panels are sequentially turned about the hinge line between the panels. The panels in a second mode are extendible from the front panel to the last panel and the respective connection features are brought into mating engagement thereby to form an enclosure.

### SUMMARY OF THE INVENTION

The present invention is generally directed to a book that includes a front cover, a binding, a rear cover and pages having content material. The binding mechanically couples the pages, the front cover and the rear cover to form the book.

The first aspect of the present invention is that the content material has been rotated ninety degrees so that a very young baby, who spends most of his time awake lying on his back, can see the content material from a right angle since his view of the content material now corresponds to the baby's perspective

Other aspects and many of the attendant advantages will be more readily appreciated as the same becomes better understood by reference to the following detailed description and considered in connection with the accompanying drawing in which like reference symbols designate like parts throughout the figures.

The features of the present invention which are believed to be novel are set forth with particularity in the appended claims.

### DESCRIPTION OF THE DRAWINGS

FIG. 1 is a schematic drawing of a children's book in accordance with the prior art.

FIG. 2 is a schematic drawing of a children's book in accordance with the present invention.

FIG. 3 is a picture of a baby reading the children's book of FIG. 2.

FIG. 4 is a picture of the children's book of FIG. 2.

FIG. 5 is a picture of a baby reading the children's book of FIG. 2.

FIG. 6 is a picture of the children's book of FIG. 2.

FIG. 7 is a picture of a baby reading the children's book of FIG. 2.

### DESCRIPTION OF THE PREFERRED EMBODIMENT

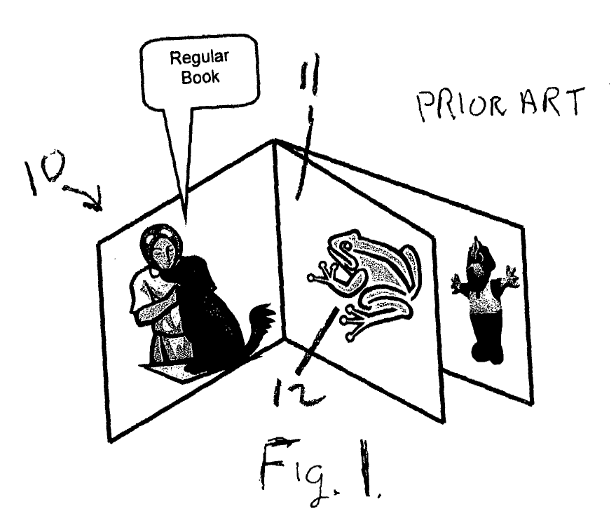

Referring to FIG. 1 a children's book 10 of the prior art has pages 11 with pictures 12 on them. Each picture 12 is oriented so that it extends perpendicularly from the bottom of one of the pages 11 to its top. Very young babies have difficulty in seeing these pictures 12 oriented this way.

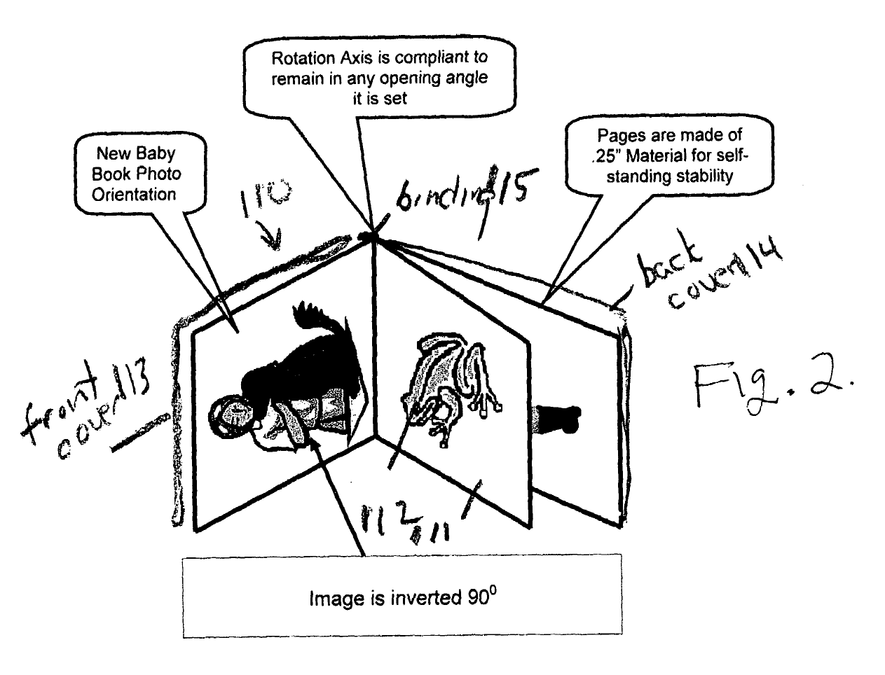

Referring to FIG. 2 a children's book 110 has pages 111 with pictures 112 on them, a front cover 113, a back cover 114 and a binding 115. The binding 115 mechanically couples the pages 112, the front cover 113 and the rear cover 114. Each picture 112 is oriented so that it extends perpendicularly from the bottom of one of the pages 111 to its top. The content material, namely pictures 112, has been rotated ninety degrees so that a very young baby who spends most of his time awake lying on his back can see the content material from a right angle since his view of the content material corresponds to the baby's perspective. Very young babies seemed to be more interested in this children's book 110 because it is on a right angle. Each page 111 has a thickness in the range of 0.15 inch to 0.3 inch in thickness so that the children's book can stand upright.

This children's book 110 catches better the baby's attention. Furthermore, either a teacher or a parent is able to redirect the baby's attention with the help of this children's book 110 thereby increasing his interest span with these books. It is natural for a very young baby to reach out and grab the children's book 110 that shows the pictures in the right way.

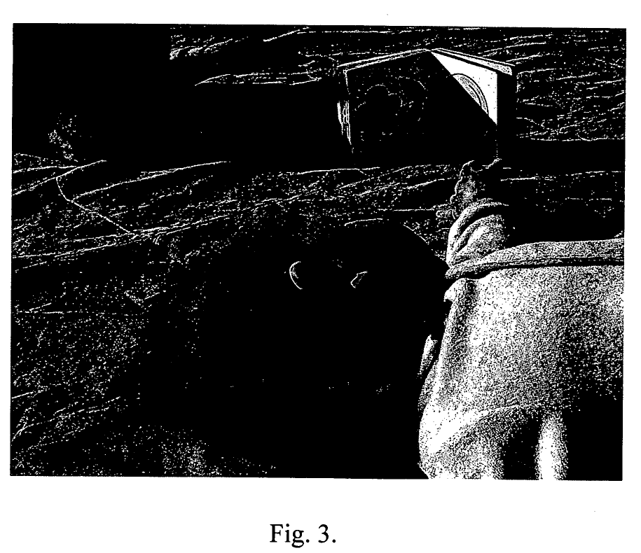

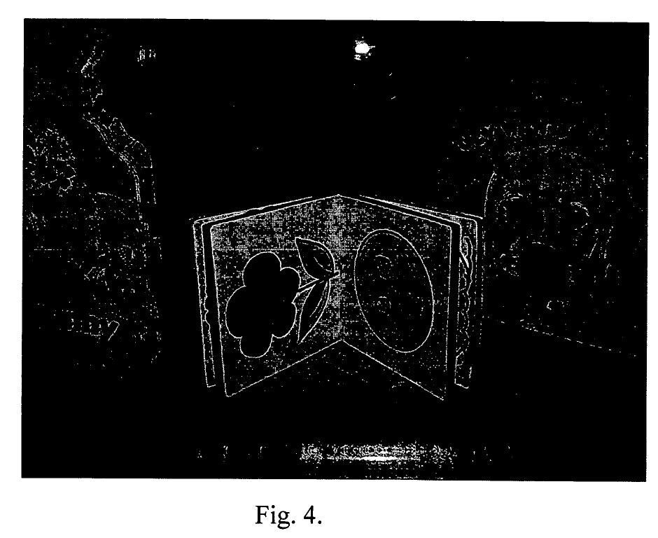

Referring to FIG. 3 in conjunction with FIG. 2 and FIG. 4 this children's book 110 is developed to create illustrated board books appropriate and natural for babies (birth to 8 months or until they are mobile) who spend most of their time awake lying on their back. Rather than seeing the pictures sideway as is the case with all other books available, this book model lets the babies see the pictures from the right angle since the pictures are sideways corresponding to the baby's perspective. This book helps the baby get into books in a natural way. This book gives the baby the right and realistic view of the object he is looking at. This children's book 110 helps develop coordination between developing brain activities and vision. This being the first step in the long process of getting into literature, this pleasant and proper experience with books will lay foundation for a healthy development. The studies show that the earlier children are exposed to books the more likely they are readers later.

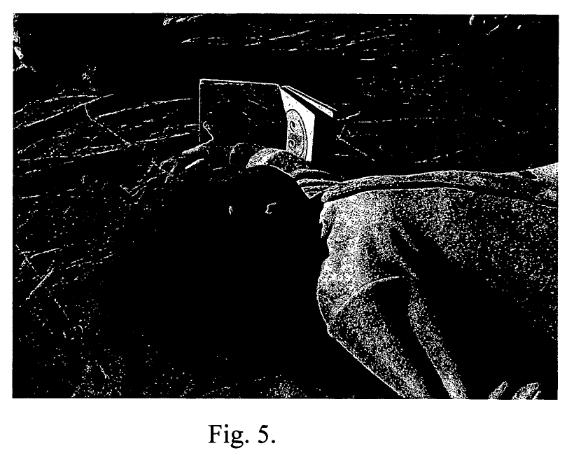

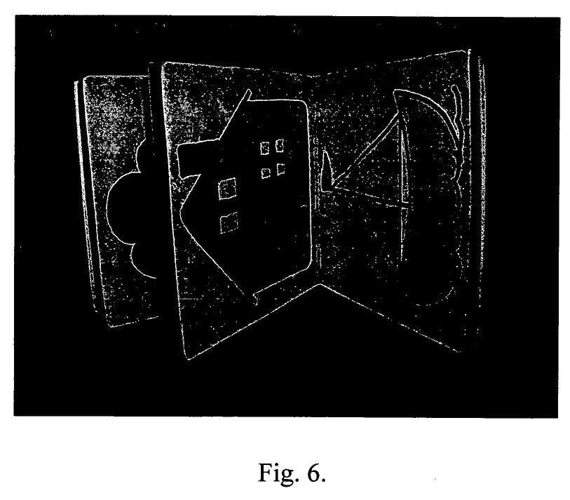

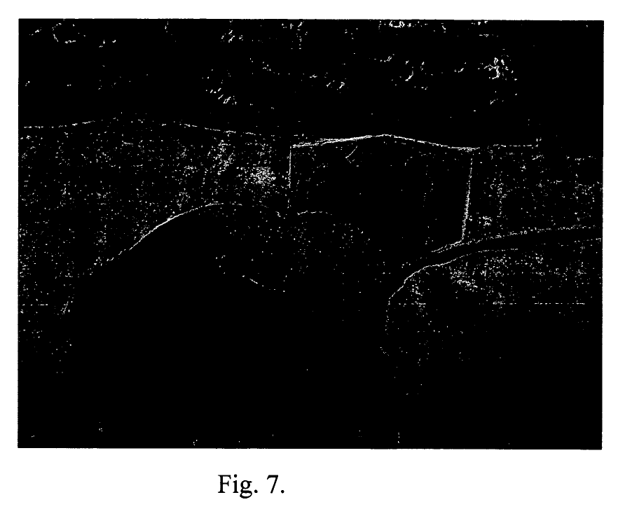

Referring to FIG. 5 in conjunction with FIG. 2, FIG. 6 and FIG. 7 I as a professionally trained and experienced infant teacher have had an opportunity to field-test this product.

From the foregoing it can be seen that a children's book for very young babies has been described. It should be noted that the sketches are not drawn to scale and that distances of and between the figures are not to be considered significant.

Accordingly it is intended that the foregoing disclosure and showing made in the drawing shall be considered only as an illustration of the principle of the present invention.

What is claimed is:

1. A book comprising:
a. a front cover;
b. a binding mechanically coupled to said front cover;
c. a rear cover mechanically coupled to said binding; and
d. a plurality of pages mechanically coupled to said binding between said front and rear covers whereby each of said pages has content material that has been rotated ninety degrees whereby a very young baby who spends most of his time awake lying on his back can see said content material from a right angle since his view of said content material corresponds to the baby's perspective.

2. A book according to claim 1 where in said content material is pictures.

3. A book according to claim 1 wherein each of said pages has a thickness in the range of 0.15 inch to 0.3 inch in thickness so that said book can stand upright.
